(19) United States
(12) Patent Application Publication
(10) Pub. No.: US 2012/0054626 A1
(43) Pub. Date: Mar. 1, 2012

(54) SERVICE LEVEL AGREEMENTS-BASED CLOUD PROVISIONING

(76) Inventor: Jens Odenheimer, Walldorf (DE)

(21) Appl. No.: 12/871,740

(22) Filed: Aug. 30, 2010

(51) Int. Cl. G06F 15/16; G06F 3/01

(52) U.S. Cl. 715/738; 709/223

(57) ABSTRACT

In an aspect there is provided a method. The method may include receiving, at a provisioning component, a first selection of one or more infrastructure parameters; receiving, at the provisioning component, a second selection of one or more platform parameters; receiving, at the provisioning component, a third selection of one or more application parameters; accessing metadata based on one or more of the first selection, the second selection, and the third selection; and providing, by the provisioning component, information to provision a cloud computing system, the information based on the accessed metadata and one or more of the first selection, the second selection, and the third selection. Related apparatus, systems, techniques and articles are also described.

### TECHNICAL FIELD

The subject matter described herein relates to cloud computing.

### BACKGROUND

Computers have now become an integral part of our society both in business and in residential settings. Almost every business of sufficient size in Germany, the United States, and other developed countries has one or more computers to assist them in running their businesses. Similarly, many families in those countries now have computers at home that are used to run various applications including games.

Some attribute the popularity of computers to the Internet. The Internet provides people with ready access to vast amounts of data. Many people now get their news, sports, stock, entertainment, and other information primarily from the Internet. Businesses have also embraced the Internet. The Internet provides the opportunity for computers to communicate instantly with other computers or individuals. Business processes that were once restricted to intranets and their users are now moving to the Internet. Accordingly, companies are moving more and more of their data to electronic forms. In addition, companies have amassed huge amounts of data in an effort to understand their business, improve performance, and build stronger employee, customer, and partner relationships.

Cloud computing is an Internet technology that provides shared resources which are accessible when needed (e.g., on demand) via the Internet. Cloud computing enables a user at a client computer to access computing resources provided by a service, such as for example a web service coupled to the Internet. The computing resources may include hardware (e.g., computing capability, storage, etc.), software (e.g., operating systems, end-user software applications, etc.), and a combination of both. Cloud computing thus allows a user to go to a single service on for example the Internet and obtain, on demand, a complete solution stack including the hardware platform and software stack, as well as end-user software applications.

### SUMMARY

In one aspect, there is provided a method. The method may include receiving, at a provisioning component, a first selection of one or more infrastructure parameters; receiving, at the provisioning component, a second selection of one or more platform parameters; receiving, at the provisioning component, a third selection of one or more application parameters; accessing metadata based on one or more of the first selection, the second selection, and the third selection; and providing, by the provisioning component, information to provision a cloud computing system, the information based on the accessed metadata and one or more of the first selection, the second selection, and the third selection.

In some implementations, one or more of the following features may be included. The metadata may include information related to provisioning the cloud computing system. The metadata may include information related to provisioning the cloud computing system, the information corresponding to one or more of infrastructure parameters, platform parameters, and application parameters. The metadata may include information related to provisioning the cloud computing system, the information corresponding to interdependencies among one or more of the infrastructure parameters, the platform parameters, and the application parameters. One or more of the first selection, the second selection, and the third selection may be modified based on the metadata, wherein the metadata includes information related to provisioning the cloud computing system, the information corresponding to interdependencies among one or more of the infrastructure parameters, the platform parameters, and the application parameters. A user interface may be provided to enable a user to select the first selection, the second selection, and the third selection. The metadata may be stored at a database separate from the provisioning component.

Articles of manufacture are also described that comprise machine executable instructions permanently stored on machine readable media (e.g., non-transitory computer readable media), which, when executed by a machine, causes the machine to perform the operations described herein. Similarly, computer systems are also described that may include a processor and a memory coupled to the processor. The memory may temporarily or permanently store one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram of a system including a provisioning layer component;

FIG. 2 is a flowchart depicting an example process for provisioning a cloud using the provisioning layer component;

FIG. 3 is a diagram illustrating service level agreements;

FIG. 4 is a flowchart depicting an example of selecting aspects of cloud provisioning using the provisioning layer component;

FIG. 5 depicts a sequence diagram including an example process for selecting aspects of cloud provisioning using the provisioning layer component.

Like reference symbols in the various drawings indicate like elements.

### DETAILED DESCRIPTION

The subject matter described herein relates to the management of a cloud computing system which comprises software-as-a-service (SaaS), infrastructure-as-a-service (IaaS), and/or platform-as-a-service (PaaS). Cloud computing as used herein refers to using one or more of software-as-a-service (SaaS), infrastructure-as-a-service (IaaS), and platform-as-a-service (PaaS). Generally, SaaS, IaaS, and PaaS represent different service level agreements (SLAs) defining levels of service.

In the case IaaS, a computer infrastructure is delivered as a service, such as for example a virtualized environment implemented on a virtual machine. A service or web service providing cloud computing resources (also referred herein as a cloud service provider) may provide an IaaS to a user at a client machine on demand. For example, the IaaS may be provided at the cloud service provider as a virtual machine (e.g., a VMware stack, a XEN stack, a Solaris-based stack, or like hypervisor being offered by the cloud service provider), an operating system (OS), and storage. Moreover, the cloud service provider integrates the virtual machine into a network and, when a plurality of virtual machines are implemented, each of the virtual machines may be isolated from other virtual machines to provide data privacy and security.

In the case of PaaS, a cloud service provider hosts a platform for developing end-user applications. In some implementations, the cloud service provider delivers a PaaS platform alone, although in some other implementations, the PaaS may be delivered in combination with an IaaS and/or a SaaS. For example, the cloud service provider may provide a PaaS for developing applications, such as for example enterprise resource planning software applications. And, in some implementations, the cloud service provider may host business applications, such as for example enterprise resource planning software applications, as a web service providing resizable compute capacity (e.g., as either a pure PaaS or as a combined PaaS and SaaS service). Unlike SaaS, a pure PaaS solution may offer a development platform without an out-of-the-box end-user application, in which case the end-using customers of a pure PaaS may be required to develop their own end-user business applications based upon the PaaS delivered platform.

In the case of SaaS, an end-user software application is delivered without the need for physical hardware other than a client processor, such as for example a computer to access the end-user SaaS application. The end-user software applications, such as for example SAP's Business byDesign or other applications, are typically used within a browser at a client processor or browser-related frontend at the client processor (e.g., Silverlight, JavaFX, and the like). SAP's Business byDesign refers to a premises-based enterprise resource planning system which enables end-user clients to access enterprise resource planning systems hosted at centralized premises.

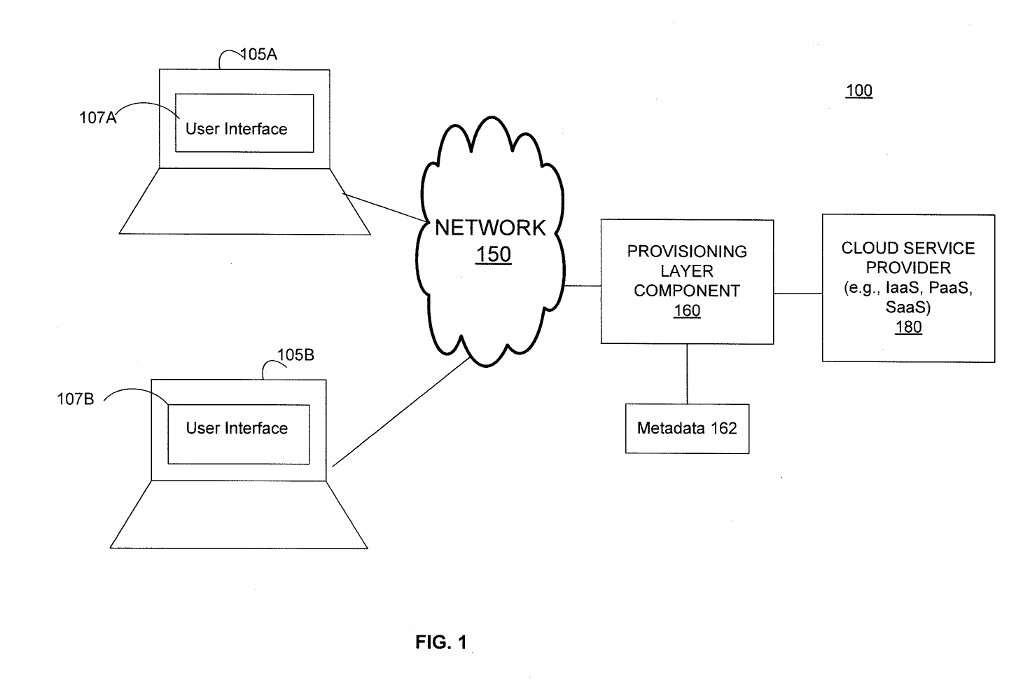

FIG. 1 depicts a system 100 including one or more computers 105A-B, a provisioning layer component 160, and a cloud service provider 180, which provides cloud computing resources, all of which are coupled by network 150. The computers 105A-B further include user interfaces 107A-B. The provisioning layer component 160 further includes and/or accesses metadata 162.

The user interfaces 107A-B may be implemented as any type of interface that enables interaction with aspects of system 100, including provisioning layer component 160 and the cloud service provider 180. For example, the user interfaces 107A-B may be implemented as a browser or a client application to interface with (and/or access) provisioning layer component 160 and the cloud service provider 180 to enable configuration (e.g., by selection at provisioning layer component 160) of the cloud computing resources at the cloud service provider 180 (e.g., enabling selection of IaaS, PaaS, and SaaS).

Provisioning layer component 160 may be used to select whether the cloud service provider 180 should provide IaaS, PaaS, and SaaS. The provisioning layer component 160 may also include metadata 162 (and/or access a separate database including the metadata). The metadata 162 may include information related to the provisioning of IaaS, PaaS, and/or SaaS. For example, the metadata 162 may include information associated with the configuration and deployment of a given end-user software application, information associated with the platform (e.g., the hardware/software stack), and information associated with the development infrastructure. For example, in the case of IaaS, the metadata may include: a quantity of central processing units (CPUs), a quantity of memory, and a quantity of storage, an operating system, and the like. In the case of PaaS, the metadata may include information, such as for example a composition environment, a web application server, a database server, and the like. In the case of SaaS, the metadata may include information related to the on demand application, such as for example an on demand customer relationship management (CRM) application, an on demand enterprise resource planning (ERP) application, and the like.

Moreover, the metadata 162 may include information associated with the interdependencies between IaaS, PaaS, and SaaS. In the case of interdependencies, the metadata may dictate that given a PaaS (e.g., a SAP Netweaver Composition Environment, a SAP Web application Server JAVA, and a SAP MaxDB Database), the IaaS may be configured by the provisioning component to include 2 central processing units (CPUs), 8 gigabytes (GB) of RAM, and 50 GB of storage for a small-scale (or small) implementation and 16 CPUs, 32 GB of RAM, and 500 GB of storage for a larger (or large) implementation.

Thus, provisioning layer component 160 may provide a single interface for orchestrating a selection and a configuration of IaaS, PaaS, and SaaS based on the metadata 162. In some implementations, the provisioning layer component 160 including metadata 162 may provide enhanced deployment of IaaS, PaaS, and SaaS reducing the complexity, from the perspective of the user, of the deployment within the cloud service provider 180.

In some implementations, the provisioning layer component 160 may be implemented as at least one processors and at least one more memory including code, which when executed by the processor allows a user at a client computer to configure and/or select aspects of the provisioning of IaaS, PaaS, and SaaS provided by the cloud service provider 180. For example, the provisioning layer component 160 may perform one or more of the following: receiving, at a provisioning component, a first selection of one or more infrastructure parameters; receiving, at the provisioning component, a second selection of one or more platform parameters; receiving, at the provisioning component, a third selection of one or more application parameters; accessing metadata based on one or more of the first selection, the second selection, and the third selection; and providing, by the provisioning component, information to provision a cloud computing system, the information based on the accessed metadata and one or more of the first selection, the second selection, and the third selection, as well as other features. Although the provisioning layer component 160 is at a given location at system 100, the provisioning layer component 160 may be located at other locations as well.

The cloud service provider 180 may be implemented as a service, such as for example a web service. The cloud service provider 180 may be implemented as a web site or a portal that allows selection, configuration, purchase, and/or use of cloud computing resources provided via the cloud service provider 180. For example, the cloud service provider 180 may be implemented as a cloud computing system at web site allowing a user to deploy SaaS, PaaS, and/or IaaS, aspects of which may be selected by a user at user interface 107A via provisioning layer component 160.

The cloud service provider 180 may provide platform resources, such as for example one or more processors (e.g., a computer, a server, a blade or any other processor). The cloud service provider 180 may also provide software, which can be offered as SaaS and an infrastructure, which can be offered as IaaS. The cloud service provider 180 may have a variety of capabilities, such as for example processing speed, memory capacity, storage capacity, and network bandwidth, i.e., bandwidth to and from network 150. Moreover, the cloud service provider 180 may have a variety of associated costs (e.g., in Dollars, Euros, time, and the like) to utilize the resources at cloud service provider 180. In some cases, the cloud service provider 180 may be located at a server facility that provides computing resources (e.g., processing capacity) for hire.

The network 150 may be any type of communications mechanism and may include, alone or in any suitable combination, intra-process communications, the Internet, an intranet, or any other communication mechanism (e.g., a telephony-based network, a local area network (LAN), a wide area network (WAN), a dedicated intranet, a wireless network, and a bus).

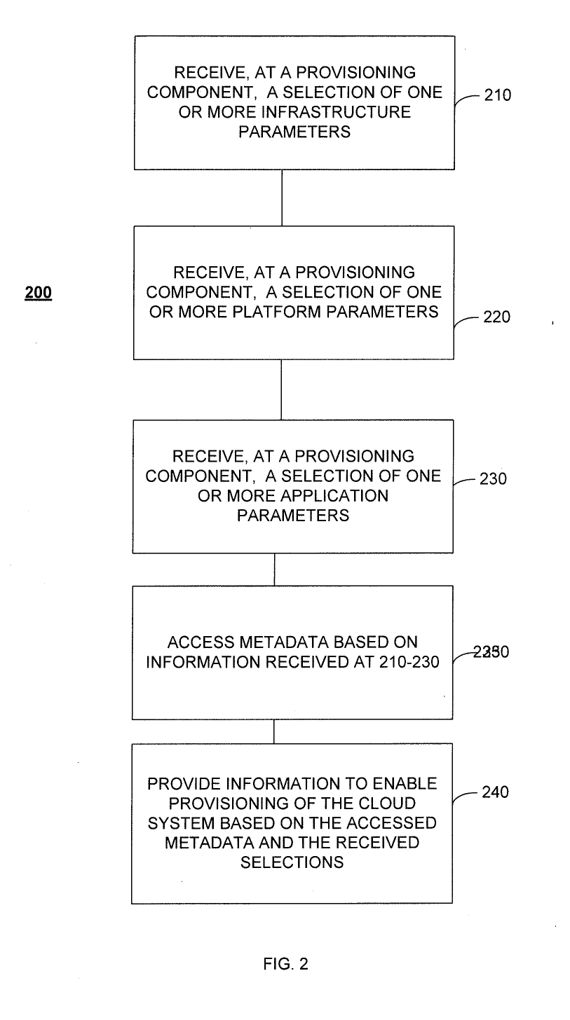

FIG. 2 depicts an example of a process 200 used to select one or more of aspects of the provisioning of IaaS, PaaS, and SaaS.

At 210, the provisioning layer component 160 receives from user interface 107A a selection of one or more infrastructure parameters. For example, the provisioning layer component 160 may receive information from user interface 107A indicating a selection of an IaaS, such as for example a selection of a development system used by developers to develop software systems, such as for example a complete Linux system or a bare bones Windows server.

At 220, the provisioning layer component 160 receives from user interface 107A a selection of one or more platform parameters. For example, the provisioning layer component 160 may receive information from user interface 107A indicating a selection of a PaaS, such as for example a selection of a hardware and/or a software stack, which can be used to host software (e.g., SAP's Netweaver Composition Environment with an IaaS package including Linux, or an SAP application server ABAP running on a Windows server).

At 230, the provisioning layer component 160 receives from user interface 107A a selection of one or more application parameters. For example, the provisioning layer component 160 may receive information from user interface 107A indicating a selection of a SaaS, such as for example a selection of an end-user software application (e.g., SAP Business byDesign, SAP Customer Relationship Management (CRM) on Demand, SAP Business Objects Business Intelligence (Be on Demand).

At 235, the provisioning layer component 160 accesses metadata 162 based on the information received at 210-230. For example, given the received parameters associated with the selection of IaaS, PaaS, and SaaS, the provisioning layer component 160 accesses metadata 162. The metadata 162 may describe interdependencies related to the provisioning of the selected IaaS, PaaS, and SaaS. For example, the metadata 162 may indicate that a selection of a given SaaS should be associated with a specific platform (e.g., a specific hardware stack and a specific software stack) and a specific development system, such as for example a SAP Business byDesign system which has an underlying SAP application server ABAP and a SAP database running on a Linux Enterprise server having 32 GB of RAM, 8 CPUs, and 2 terabytes of storage, although other configurations and systems may be used as well. The metadata 162 may represent one or more service level agreements with an end-user entity.

The metadata 162 may augment and/or modify the received information of 210-230. For example, if a user selects an operating system that is incompatible with the selected SaaS, the provisioning layer component 160 may modify the user selection received at 220 with a compatible operating system.

At 240, the provisioning layer component 160 provides the received information, which may be augmented and/or modified by the metadata 162, to the cloud provisioning service 180, which then configures and provides the IaaS, PaaS, and/or SaaS to one or more users.

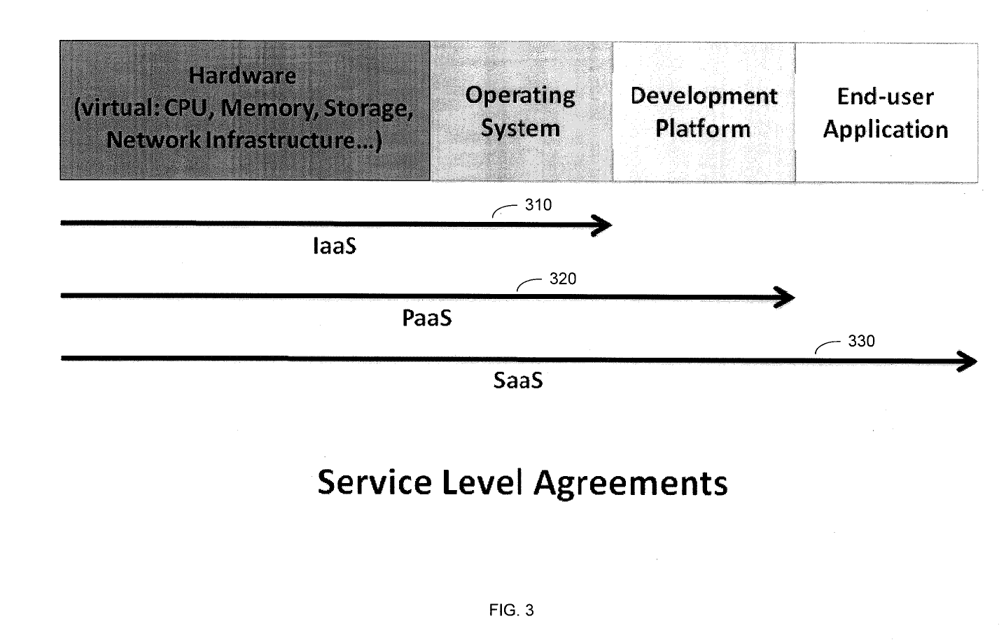

FIG. 3 depicts the relationships between service level agreements and IaaS, PaaS, and SaaS. Generally, IaaS 310, PaaS 320, and SaaS 330 each represent different service level agreements. For example, IaaS 310 may define a service level agreement for hardware aspects of the platform including virtualization, a central processing unit, memory, storage, network infrastructure, and the like; IaaS 310 may also generally also define a service level agreement for an operating system; PaaS 320 may define a service level agreement for the development platform provided on top of the infrastructure (which may also include an operating system and/or hardware aspects); and the SaaS 330 may define a service level agreement for the software application (which may also include a development platform, an operating system, and/or hardware aspects).

In some cases, the following provisioning options may be provided: a pure IaaS; a pure PaaS; PaaS and IaaS; pure SaaS; SaaS and PaaS; and SaaS, PaaS, and IaaS. The term “pure” refers to the cloud service provider 180 providing only one of IaaS, PaaS, or SaaS. The following provides some example use cases for these options, although other example use cases may be realized as well.

In the case of a pure IaaS, an end-user may select a machine with root access for running/testing special applications, such as for example a new software application to be tested before deployment on an operational network. In this case, to test the new software application before deployment, the end-user may access provisioning layer component 160 to select an amount/capability of a central processing unit, a quantity of main memory, storage, and a network security level for the cloud service provider 180.

Another example of a pure IaaS use case is the case of an end-user having a temporary task. For example, an end-user may have a temporary (or one-time) task to convert a plurality of files in an enterprise from a first format (e.g., a video AVI file) to another format (e.g., Adobe Flash). In this example, the end-user accesses one or more virtual machines hosted by the cloud service provider 180 and configured by the end-user via provisioning layer component 160 to perform the conversion.

An example use case of pure PaaS is as follows. A developer of end-user applications that run on a SAP Java Enterprise Server platform may not want to deal with the details of SAP Java Enterprise Server platform implementations. In this example, the developer may access provisioning layer component 160 to provision a service 180 that provides a pure PaaS, which in this example is a SAP Java Enterprise Server platform to allow the developer to develop the application.

An example use case of a PaaS and an IaaS is as follows. A company which develops an application has been doing so for some time using a given platform but the company becomes faced with the limitations of a given PaaS stack, such as for example the limitations of a specific database and a particular operating system. To avoid the limitations, the company may want to develop the application on the same platform and provide the increased flexibility of other underlying databases or operating systems. In this use case, the company may configure at provisioning layer component 160 a service 180 that provides a PaaS and an IaaS.

An example use case of a pure SaaS is as follows. A company may have an existing customer relationship management (CRM) system but wants to implement another CRM system, without interfering with the company's local information technology system landscape. In this example, the company can access provisioning layer component 160 to configure the cloud service provider 180 to provide the CRM system at the cloud 180.

An example use case of a SaaS and PaaS is as follows. A company (which uses an existing SaaS product) may want to provide an add-on to the SaaS product which is not part of that SaaS product. In this example, the company can select at provisioning layer component 160 the underlying platform to be provisioned at cloud service provider 180 and write the ad-on/co-application that works with the SaaS product.

An example use case of a SaaS, PaaS, and IaaS is as follows. A company may have a SaaS product and an underlying platform. However, the standard CPU/memory ratio of the platform may not be optimal for the company, and the support contract for the operating system, database, and platform for the SaaS product may be at a costly, premium service level. In this case, a user may access provisioning layer component 160 to configure the cloud service provider 180 to provide the SaaS, PaaS, and IaaS to enable a migration to the platform/infrastructure of the cloud service provider 180 at a lower cost and/or higher service level.

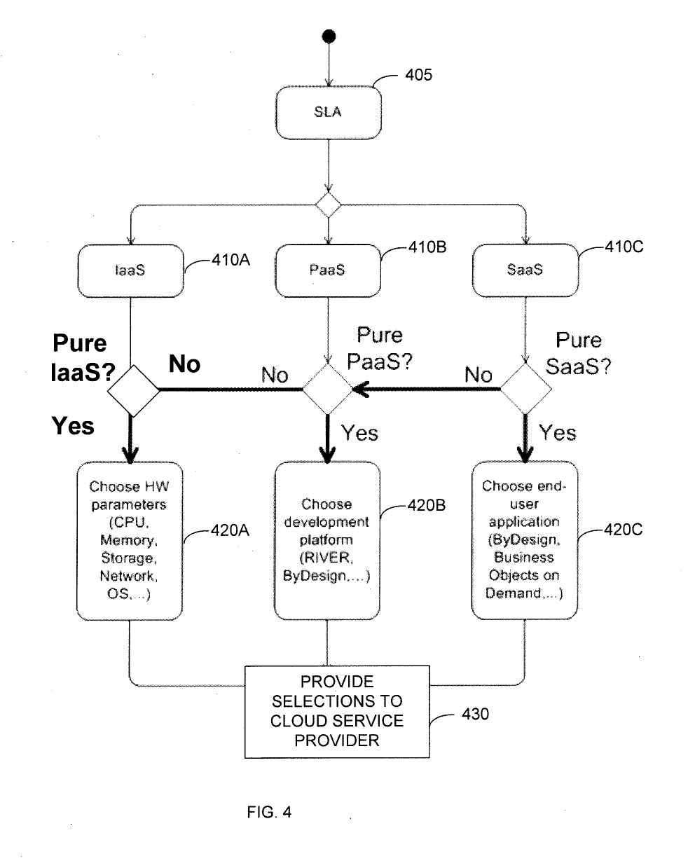

FIG. 4 depicts an example of a process to allow selection of IaaS, PaaS, and/or SaaS. The metadata 162 defines interdependencies among the IaaS, PaaS, and/or SaaS. For example, metadata 162 may define rules for the hardware stack and/or software stack, such as for example so-called “stack regulations.” The provisioning component layer 160 may thus orchestrate based on metadata 162 the selection of PaaS, IaaS, and SaaS by enforcing only allowable combinations/configurations of IaaS, PaaS, and/or SaaS.

At 405, a service level agreement defines IaaS 410A, PaaS 410B, and SaaS 410C to be selected via provisioning layer component 160. Based on selections received at the provisioning layer component 160 from a user at a client computer 105A and/or 105B, the provisioning layer component 160 chooses a corresponding set of parameters at 420A-C. Moreover, the provisioning layer component 160 may also use the metadata 162 to make sure that the chosen stacks comply with the metadata (e.g., are consistent with interdependencies among a given IaaS, PaaS, and SaaS, do not violate any stack regulations, and the like). At 430, the chosen stacks are provided by provisioning layer component 160 to the cloud service provider 180 and, in some implementations, provided by provisioning layer component 160 to the user interface 107A for presentation (e.g., at a browser).

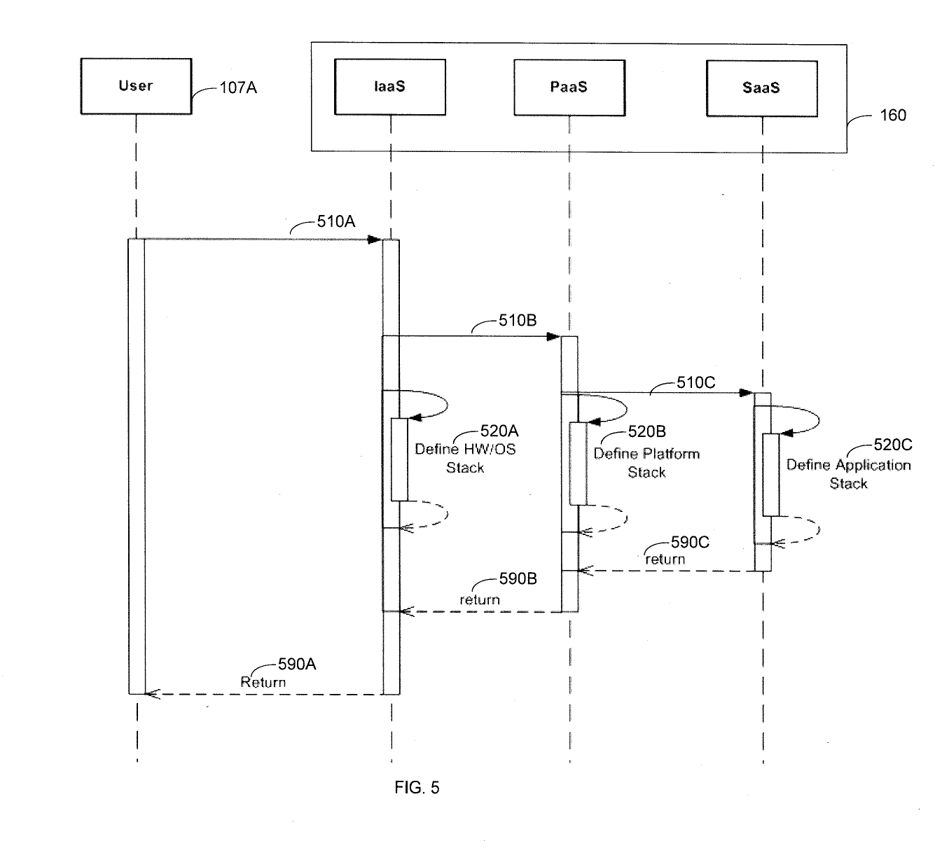

FIG. 5 depicts a process for SLA-based cloud provisioning for selecting IaaS, PaaS, and/or SaaS.

A user at user interface 107A may provide to provisioning layer component 160 information associated with the selection of an IaaS, PaaS, and SaaS. For example, a selection at user interface 107A may result in one or more messages 510A-C including information associated with the selection of IaaS, PaaS, and SaaS. At 520A-C the provisioning layer component 160 may define the hardware/software stack, platform stack, and application stack. Moreover, the provisioning layer component 160 may also use the metadata 162 to define the hardware/software stack, platform stack, and application stack to make sure that the defined stacks comply with the metadata 162 (e.g., are consistent with interdependencies among a given IaaS, PaaS, and SaaS, do not violate any stack regulations, and the like). At 590C-A, the defined stacks of 520A-C may be provided to user interface 107 for presentation (e.g., at a browser). The defined stacks of 520A-C may be provided by provisioning layer component 160 to the cloud service provider 180 to configure the cloud computing system.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss cloud computing, the current subject matter is applicable to other types of software and data services access as well. Moreover, although the above description makes references to specific products, other products may be used as well. In addition, the logic flows depicted in the accompanying figures and described herein do not require the particular order shown, or sequential order, to achieve desirable results. Other embodiments may be within the scope of the following claims.

What is claimed:

1. A machine-readable storage medium including code which when executed by a machine provides operations comprising:
receiving, at a provisioning component, a first selection of one or more infrastructure parameters;
receiving, at the provisioning component, a second selection of one or more platform parameters;
receiving, at the provisioning component, a third selection of one or more application parameters;
accessing metadata based on one or more of the first selection, the second selection, and the third selection; and
providing, by the provisioning component, information to provision a cloud computing system, the information based on the accessed metadata and one or more of the first selection, the second selection, and the third selection.

2. The machine-readable storage of claim 1, wherein the metadata includes information related to provisioning the cloud computing system.

3. The machine-readable storage of claim 1, wherein the metadata includes information related to provisioning the cloud computing system, the information corresponding to one or more of infrastructure parameters, platform parameters, and application parameters.

4. The machine-readable storage of claim 1, wherein the metadata includes information related to provisioning the cloud computing system, the information corresponding to interdependencies among one or more of the infrastructure parameters, the platform parameters, and the application parameters.

5. The machine-readable storage of claim 1 further comprising:
modifying, based on the metadata, one or more of the first selection, the second selection, and the third selection, the metadata including information related to provisioning the cloud computing system, the information corresponding to interdependencies among one or more of the infrastructure parameters, the platform parameters, and the application parameters.

6. The machine-readable storage of claim 1 further comprising:
providing a user interface to enable a user to select the first selection, the second selection, and the third selection.

7. The machine-readable storage of claim 1, wherein the metadata is stored at a database separate from the provisioning component.

8. A method comprising:
receiving, at a provisioning component, a first selection of one or more infrastructure parameters;
receiving, at the provisioning component, a second selection of one or more platform parameters;
receiving, at the provisioning component, a third selection of one or more application parameters;
accessing metadata based on one or more of the first selection, the second selection, and the third selection; and
providing, by the provisioning component, information to provision a cloud computing system, the information based on the accessed metadata and one or more of the first selection, the second selection, and the third selection, wherein the provisioning component is implemented on at least one processor.

9. The method of claim 8, wherein the metadata includes information related to provisioning the cloud computing system.

10. The method of claim 8, wherein the metadata includes information related to provisioning the cloud computing system, the information corresponding to one or more of infrastructure parameters, platform parameters, and application parameters.

11. The method of claim 8, wherein the metadata includes information related to provisioning the cloud computing system, the information corresponding to interdependencies among one or more of the infrastructure parameters, the platform parameters, and the application parameters.

12. The method of claim 8 further comprising:
modifying, based on the metadata, one or more of the first selection, the second selection, and the third selection, the metadata including information related to provisioning the cloud computing system, the information corresponding to interdependencies among one or more of the infrastructure parameters, the platform parameters, and the application parameters.

13. The method of claim 8 further comprising:
providing a user interface to enable a user to select the first selection, the second selection, and the third selection.

14. The method of claim 8, wherein the metadata is stored at a database separate from the provisioning component.

15. A system comprising:
at least one processor; and
at least one memory, wherein the at least one processor and the at least one memory including code configure the system to provide operations comprising:
receiving, at a provisioning component, a first selection of one or more infrastructure parameters;
receiving, at the provisioning component, a second selection of one or more platform parameters;
receiving, at the provisioning component, a third selection of one or more application parameters;
accessing metadata based on one or more of the first selection, the second selection, and the third selection; and
providing, by the provisioning component, information to provision a cloud computing system, the information based on the accessed metadata and one or more of the first selection, the second selection, and the third selection, wherein the provisioning component is implemented on at least one processor.

16. The system of claim 15, wherein the metadata includes information related to provisioning the cloud computing system.

17. The system of claim 15, wherein the metadata includes information related to provisioning the cloud computing system, the information corresponding to one or more of infrastructure parameters, platform parameters, and application parameters.

18. The system of claim 15, wherein the metadata includes information related to provisioning the cloud computing system, the information corresponding to interdependencies among one or more of the infrastructure parameters, the platform parameters, and the application parameters.

19. The system of claim 15 further comprising:
modifying, based on the metadata, one or more of the first selection, the second selection, and the third selection, the metadata including information related to provisioning the cloud computing system, the information corresponding to interdependencies among one or more of the infrastructure parameters, the platform parameters, and the application parameters.

20. The system of claim 15 further comprising:
providing a user interface to enable a user to select the first selection, the second selection, and the third selection.
